(19) United States
(12) Patent Application Publication
(10) Pub. No.: US 2024/0038408 A1
(43) Pub. Date: Feb. 1, 2024

(54) MATERIALS FOR TUNGSTEN BORIDE NEUTRON SHIELDING

(71) Applicants: Tokamak Energy Ltd, Abingdon Oxfordshire (GB); Imperial College Innovations Limited, London Greater London (GB)

(72) Inventors: Jack Astbury, Abingdon Oxfordshire (GB); Colin Windsor, Abingdon Oxfordshire (GB); Samuel A. Humphry-Baker, London Greater London (GB); James Davidson, London Greater London (GB); Charles McFadzean, London Greater London (GB)

(21) Appl. No.: 18/258,985

(22) PCT Filed: Dec. 21, 2021
(86) PCT No.: PCT/EP2021/087149

§ 371 Date: Jun. 22, 2023

(30) Foreign Application Priority Data
Dec. 22, 2020 (GB) 2020390.7
Sep. 23, 2021 (GB) 2113587.6

(51) Int. Cl. G21F 1/06; G21F 1/08; G21B 1/05

(52) U.S. Cl. CPC G21F 1/06; G21F 1/08; G21B 1/057

(57) ABSTRACT

The use of di-tungsten penta-boride, W₂B₅, within a neutron shield is disclosed.

### FIELD OF THE INVENTION

The present invention relates to neutron shielding materials for fusion reactors. In particular, this invention relates to neutron shielding comprising tungsten boride.

### BACKGROUND

The challenge of producing fusion power is hugely complex. Fusion neutrons are produced when a deuterium-tritium (D-T) or deuterium-deuterium (D-D) plasma are heated so that the nuclei have sufficient energy to overcome the Coulomb electrostatic repulsion to fuse together, releasing energetic neutrons and fusion products (e.g. ⁴He for D-T). To date, the most promising way of achieving this is to use a tokamak device; in the conventional tokamak approach to fusion (as embodied by ITER), the plasma needs to have high confinement time, high temperature, and high density to optimise this process.

A tokamak features a combination of strong toroidal magnetic field Br, high plasma current Iₚ and usually a large plasma volume and significant auxiliary heating, to provide a hot stable plasma so that fusion can occur. The auxiliary heating (for example via tens of megawatts of neutral beam injection of high energy H, D or T) is necessary to increase the temperature to the sufficiently high values required for nuclear fusion to occur, and/or to maintain the plasma current.

In order to ensure that the reactor is as compact as possible (which allows greater efficiency, particularly for a “spherical tokamak” plasma configuration), the thickness of radiation shielding should be reduced as much as possible, while still maintaining adequate protection for the other components. Minimising the distance between the plasma and the field coils allows a higher magnetic field in the plasma with a lower current in the coils.

FIG. 1 shows a section of the central column, and illustrates the problems which the shielding material must overcome. The central column comprises a central core of High Temperature Superconductor (HTS) coils 11 and an outer layer of shielding 12.

Depending on the material used for the shielding, there may be a layer of oxidised shielding material 13 on the outer surface, if the shield is exposed to air while operating at high temperature. There are three major causes of damage which originate from the plasma 14. Firstly, the high energy neutrons 15 generated by the fusion reaction can essentially knock atoms out of the structure of the shielding, creating damage cascades 16 which propagate through the material and degrade the materials properties (such as mechanical, thermal or superconducting properties). Secondly, the heat flux 17 from the fusion reaction is significant, and can damage the shielding due to thermal stresses induced by uneven heating and the HTS core, as higher temperatures reduces the current that can be carried while maintaining superconductivity, and can cause the coil to suddenly gain resistance, causing the magnet to quench. Lastly, the energetic particles of the plasma will ablate 18 the outer surface of the shielding. This not only causes damage to the shielding itself, but can also contaminate the plasma if the shielding is directly exposed to it. It is desirable to have a shielding material which can resist these effects, as well as prevent neutrons from reaching the superconducting coils.

Current shielding designs also often make use of water channels both for cooling the shield, and for moderating the neutrons (which increases the effectiveness of the shielding). However, this presents issues as the water is difficult to handle during disposal or maintenance of the application—due to the risks of pressured systems, contamination, activation and vaporisation of the water, and the possibility of water from the reactor getting into the environment if mishandled.

There is therefore a need for an effective neutron shield which does not require water for moderation.

### SUMMARY

According to a first aspect of the invention, there is provided the use of di-tungsten penta-boride, W₂B₅, within a neutron shield.

According to a second aspect, there is provided neutron shielding comprising di-tungsten penta-boride, W₂B₅.

According to a third aspect, there is provided a tokamak fusion reactor comprising a plasma chamber, a toroidal field coil, a plurality of poloidal field coils, and neutron shielding located between the interior of the plasma chamber and the toroidal or poloidal field coils, wherein the neutron shielding is shielding according to the second aspect.

### BRIEF DESCRIPTION OF THE DRAWINGS

FIG. 1 is a schematic illustration of a shielding layer in the central column of a tokamak;

FIG. 2 is a graph showing neutron flux for tungsten boride and carbide shielding materials;

FIG. 3 is a graph showing energy deposition from neutrons and from gammas for tungsten boride and carbide shielding materials;

FIG. 4 is a graph showing the atomic densities within the shield materials for tungsten for boron or carbon and their sum;

FIG. 5 is a graph showing the fraction of the ¹⁰B isotope remaining after 30 years of operation for the tungsten boride materials as a function of boron content at different levels within a neutron shield;

FIG. 6 is a graph showing the peak neutron flux in the HTS core (as in FIG. 1) for different isotopic concentrations of the ¹⁰B isotope in the shield materials.

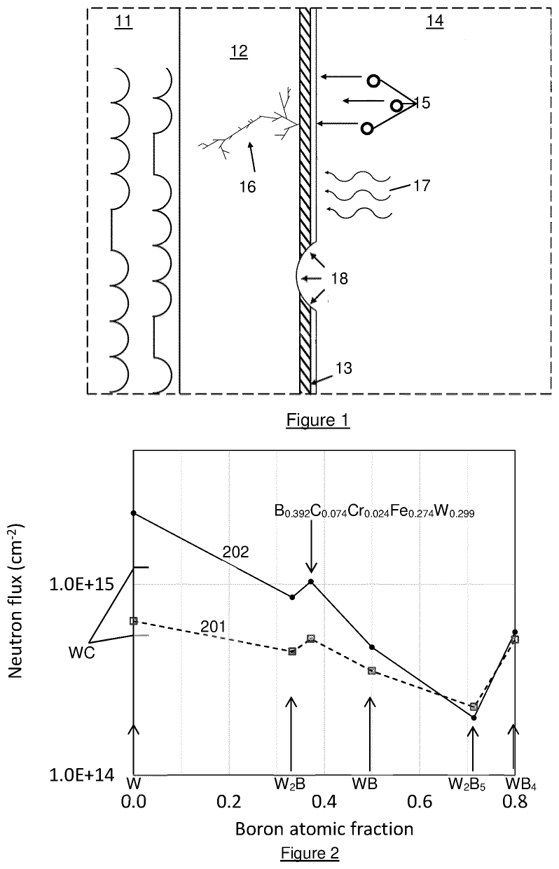

### DETAILED DESCRIPTION

Previous neutron shielding concepts have been based on tungsten carbides and/or borides rich in tungsten. Tungsten is an effective photon absorber due to its high Z number, as well as a typically high density of tungsten compounds. Tungsten is also effective as an inelastic scatterer in reducing the energies of incident neutrons at ˜14 MeV. Tungsten carbide provides additional advantages in that carbon is a somewhat effective neutron moderator (in brief, slowing down the neutrons to make them easier for the tungsten to absorb). Tungsten boride provides additional advantages in that boron is an effective absorber of low-energy neutrons which may be able to penetrate a generally tungsten-based shield.

During a study of possible compositions of tungsten carbides and borides, it has been surprisingly found that a particular stoichiometry of tungsten boride, W₂B₅ (di-tungsten penta-boride) is a significantly more effective shielding material than other tungsten borides or carbides, both for gamma rays and neutrons, at the intensities and energy ranges expected in a tokamak nuclear fusion reactor.

FIG. 2 shows the results of a simulation of various tungsten boride materials (with tungsten and tungsten carbide as comparisons), for neutron absorption, either with 201 or without 202 a water moderator layer. The measurement is of the neutron flux onto a high temperature superconducting HTS central column of a tokamak fusion reactor, so lower values are better. The scale is logarithmic. The tungsten borides considered are W₂B, WB, W₂B₅, and WB₄. Additionally, tungsten carbide (WC, indicated as horizontal lines from the Y axis) and a more complex composite material, B_{0.329}C_{0.074}Cr_{0.024}Fe_{0.274}W_{0.299} are considered.

As can be seen from the chart, W₂B₅ significantly outperforms the other compositions for neutron absorption. In fact, it is a sufficiently good absorber that performance increases when the water moderator is replaced by more W₂B₅, since the moderating effect of the water does not provide enough of a boost to the remaining W₂B₅ to account for the material removed to make space for the moderator—i.e. usually the presence of a moderator would allow more neutrons to be absorbed due to the larger cross section for absorption of slower neutrons, but this effect is fully counteracted by the increased absorption ability of W₂B₅.

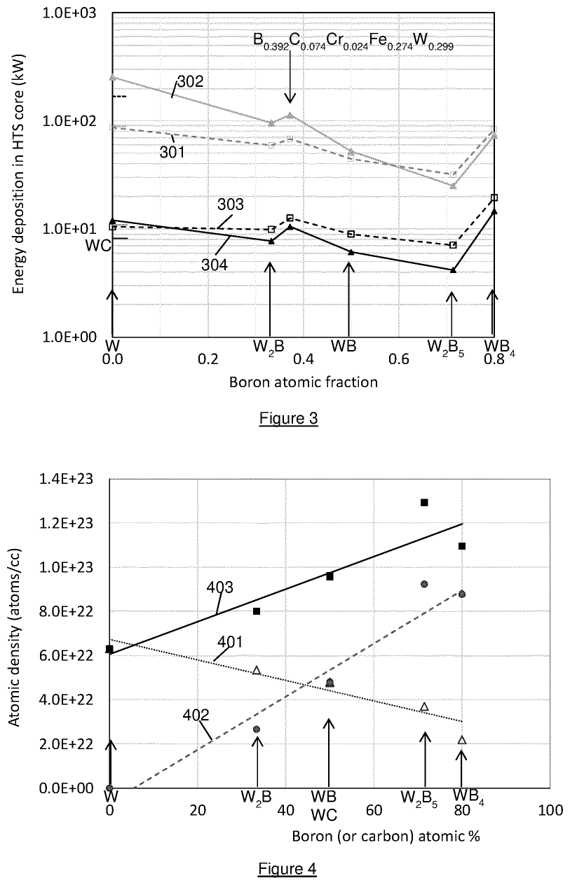

FIG. 3 shows the actual energy deposition on the HTS material in the same simulation as FIG. 2, for both direct energy deposition by neutrons and secondary energy deposition by gamma rays. The graphs shown are for gamma energy deposition with 301 and without 302 a water moderator, and for neutron energy deposition with 303 and without 304 a water moderator. As previously, lower values are better, and the same compounds are plotted. In this chart it can be seen that W₂B₅ is again the best performer in all cases. The direct energy deposition by neutrons is higher without a water moderator, despite the neutron flux being lower, because neutrons which reach the HTS have higher energy. However, the secondary deposition via gamma rays is lower for W₂B₅ without a moderator, and given the logarithmic scale of the graph it will be appreciated that the total energy deposition will also be lower in this case.

It is theorised that this occurs due to the particularly close-packed crystal structure of W₂B₅, which has an anomalously high density among tungsten borides (˜13 g/cm³) and therefore a larger atomic number density (i.e. number of atoms per unit volume) of both tungsten and boron than would otherwise be expected when compared to other stoichiometries. This is shown in FIG. 3, which show the atomic density (in atoms per cubic centimetre) of tungsten 401 and boron or carbon 402, and their total 403 for various stoichiometries of pure tungsten, tungsten carbide and tungsten boride. As can be seen, W₂B₅ has the highest atomic density of boron of all the stoichiometries considered, and is well above the trend line for the atomic density of tungsten. The total atomic density, including both tungsten and boron, is also highest. This is important because both boron and tungsten play important roles in the shield.

It should be noted that there is some debate within the scientific community as to the exact structure of W₂B₅. It is known that there exists a phase of tungsten boride comprising alternating layers of boron consisting of graphite-like planar layers and condensed cyclohexane-like chairs with tungsten atoms located between the boron layers, in a structure with space group P6₃/mmc. For this structure to be W₂B₅, the centre of each cyclohexane-like ring would contain an additional boron atom, and the debate centres around whether this arrangement is stable. Where the additional boron atom is completely absent, the structure would be correctly identified as W₂B₄, and where there is only a partial occupation (i.e. the boron atom is present in some units of the structure, but not others), the structure would be correctly identified as W₂B₄₊ₓ. However, W₂B₅ is the most common description of this structure in the literature, and is therefore the term used herein. In the event that the W₂B₄ or W₂B₄₊ₓ structure is correct, the proportion of boron within the phase will be slightly lower than described herein, but the overall conclusions of this being the best phase for use in neutron shielding remain the same, and mentions of W₂B₅ herein can be substituted for mentions of the correct formula.

Other phases may be present in lesser proportions within the boride, but the desired phase (i.e. W₂B₄, W₂B₄₊ₓ, or W₂B₅) will dominate.

In general, W₂B₅ can be incorporated into any existing designs using other tungsten boride formulations. For example, it may be incorporated as solid sintered W₂B₅, or as the tungsten boride component in a cemented tungsten boride comprising W₂B₅ particles within a metal binder. While the above results show that a moderator is not necessary, the W₂B₅ based shielding may still be provided with a moderator such as water or another hydrogen-containing material, or any other suitable neutron moderator as known in the art. For example, providing a moderator may be beneficial when the W₂B₅ is included as part of a composite material such as a cermet, ceramic, or cemented tungsten boride, such that the combination of the composite material and the moderator provides better neutron absorption at the target range than the composite material alone. A moderator may also be beneficial where the expected neutron energy is different to the 14.1 MeV fusion neutrons used for the simulations discussed above, and/or where water (or another moderating material) is used both as a moderator and for cooling the neutron shielding or other nearby components.

W₂B₅ may be provided as one component on composite shielding, e.g including further materials to provide additional absorption for gamma rays, neutrons at different energies, or any other radiation types. W₂B₅ shielding may comprise structural components and cooling components, which may be made from any suitable material.

It should be appreciated that the advantages of W₂B₅ lie mainly in its performance as a shielding material, rather than being specific to any particular shielding application (e.g. geometry or structure).

The increased neutron absorption for a given thickness of neutron shielding may be used to provide improved absorption for shielding of a set thickness compared to other tungsten boride based solutions, or it may be used to provide a similar degree of neutron shielding with a reduced thickness compared to other tungsten boride based solutions. The latter is particularly useful in applications such as the central column of a spherical tokamak fusion reactor, where the minimising the thickness of the shielding (as part of minimising the overall diameter of the central column) is an important design goal.

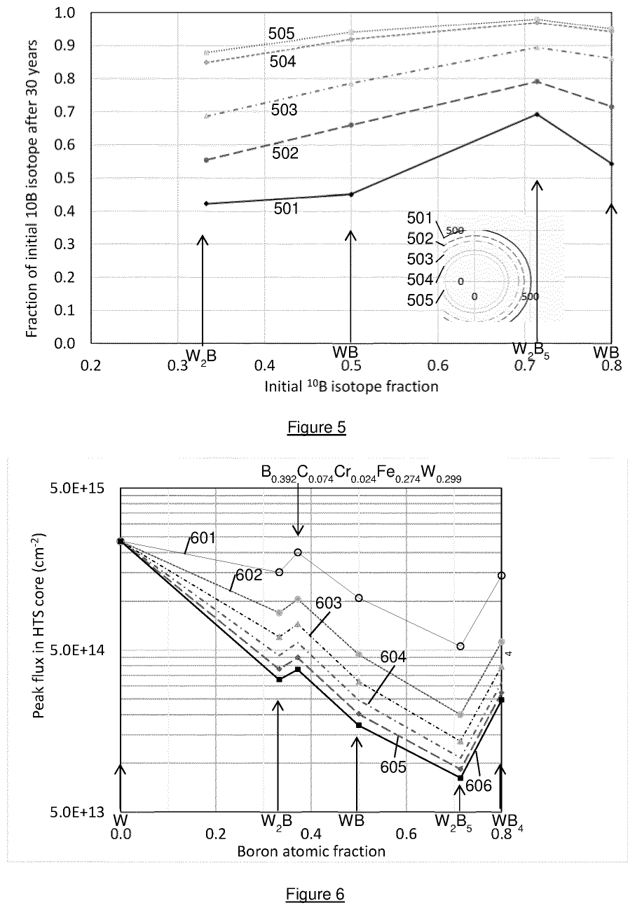

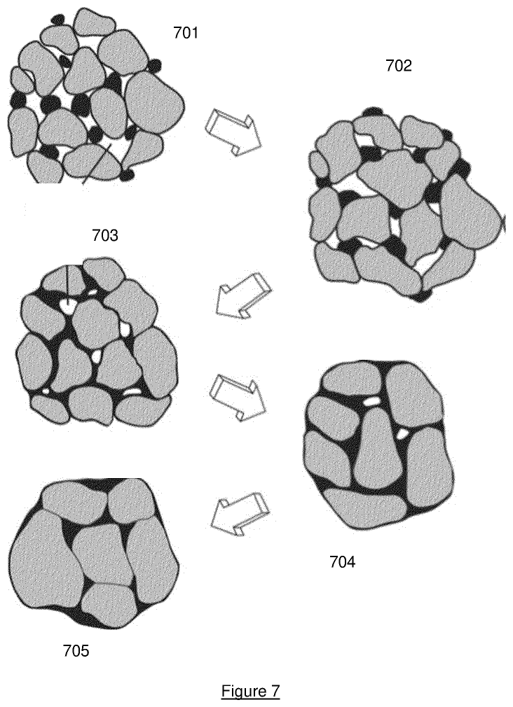

A potential problem of existing shields which benefit from the absorption of neutrons by boron is that the absorbing ¹⁰B isotope is transmuted to ⁷Li and an ⁴He alpha particle so that the fraction of the ¹⁰B isotope is gradually reduced over time. This is illustrated in FIG. 5 which shows the boron-10 fraction remaining for several tungsten borides after 30 years of operation at 200 MW plotted against material for several positions within the shield from the plasma facing surface 501 to the HTS core facing surface 505, with intermediate depths 502, 503, 504 as shown in the schematic 500. The fractional loss is highest on the outer plasma facing surface where the neutron flux is highest and reduces through the shield. The W₂B₅ shows the best performance of all the materials considered in this respect with the smallest fractional reduction of isotopic content throughout the shield.

Natural boron has an isotopic content of 19 to 20% of the neutron-absorbing ¹⁰B compared with 80% of ¹¹B (other isotopes of boron have a half life on the order of tens to hundreds of milliseconds, at most). While the use of natural boron or other boron having 18 to 20% ¹⁰B will be sufficient in many applications, the performance of boride shields could be enhanced by enriching the ¹⁰B content, i.e. providing a greater fraction of ¹⁰B than is present in naturally occurring boron, e.g. at least 25% ¹⁰B. The effect of this on the peak neutron flux within the HTS core for each of the tungsten boride materials is shown in FIG. 6, for proportions of ¹⁰B/Bₜₒₜₐₗ of 0% 601, 20% 602, 40% 603, 60% 604, 80% 605, and 100% 606. The higher percentages of ¹⁰B improve the shield performance by over a factor of 2 for each of the tungsten borides, but W₂B₅ remains the best tungsten boride at all enrichment levels. Similar results are obtained for neutron and gamma energy deposition within the core (not shown).

W₂B₅ could be formed as a pure solid material through fabrication techniques such as sintering, or melting and casting. The sintering of W₂B₅ may be performed by spark plasma sintering, hot pressing of W₂B₅ powders, pressureless sintering, or other suitable methods.

Alternatively, a relatively inexpensive fabrication route would be a composite cemented tungsten boride.

Pure W₂B₅ has excellent neutron shielding properties, but is generally brittle. To mitigate this, W₂B₅ may be provided within a metal-reinforced composite, in order to provide appropriate physical properties for structural (e.g. load bearing) use of the W₂B₅ composite.

The additive alloying metallic element to improve structural performance should be chosen so as not to react strongly with borides, as part of the benefits of W₂B₅ come from its structure, and that structure will be compromised or lost if a large proportion of it reacts with other elements in the composite to form other borides. In particular, suitable metals to provide with W₂B₅ within a metal-reinforced composite include transition metals (e.g. tungsten), preferably those from group 11 of the periodic table (copper, silver, and gold), zinc, or lead, more preferably copper. Alloys primarily composed of such metals are also suitable, for example bronzes and brasses such as gilding metal, phosphor or aluminium bronze, red brass, beryllium copper, and cupronickel, or alloys of gold and/or silver such as electrum or goloid. While aluminium does react to form borides, forming significant quantities of WAIB requires specific compositions and cooling rates. As such, by controlling the compositions and cooling rates to limit the formation of WAIB, aluminium may be used as the additive alloying metallic element.

As an example of a metal reinforced composite, the W₂B₅ may be provided as a component in the aggregate of a cemented tungsten boride comprising a metal matrix and an aggregate, as was described for WB in WO 2016/009176 A1.

The metal reinforced composite may comprise a high proportion of W₂B₅, e.g. at least 70% by weight, at least 80% by weight, or at least 90% by weight. This will result in a significant proportion of boron in the material, as W₂B₅ is 12.8% boron by weight, so a composite comprising N % W₂B₅ by weight comprises at least 0.128N % boron by weight. As such the metal reinforced composite may comprise at least 9% boron by weight, at least 10% boron by weight, or at least 11.5% boron by weight.

Neutron-attenuation performance of the metal-reinforced composite generally improves with increasing boron content.

Metal reinforced composites may be formed in a number of ways, for example by liquid phase sintering (LPS), as illustrated in FIG. 7. To form a composite by LPS, W₂B₅ powder is mixed with powder of the chosen metal 701, and optionally additives such as stearic acid (approx. 1% by weight of W₂B₅) to reduce the frequency of cold welding during pre-processing. The powders may be milled together under an inert atmosphere to reduce their average particle size. The mixed powders are pressed 702 to form a “green compact”, which is then heated to above the melting point of the chosen metal, such that it becomes liquid. Capillary forces due to the wetting of the solid W₂B₅ by the liquid metal will pull the liquid into the interparticle voids and cause the particles to rearrange 703. As the porosity is eliminated and the rearrangement phase begins to slow, diffusion mechanisms become dominant as W₂B₅ diffuses through the liquid and reprecipitates onto other particles 704. This causes larger grains to grow at the expense of smaller grains, and tends to flatten curved particle surfaces which are in contact. These shape changes cause the W₂B₅ particles to pack more tightly. In the final stage 705, the composite reaches its highest density as the W₂B₅ structure strengthens with the formation of a solid microstructure, in a manner analogous to solid phase sintering. The composite is then allowed to cool so that the liquid metal solidifies into a continuous matrix around the W₂B₅ structure.

The sintering may be performed under pressure, e.g. in a hot press, or “pressureless” sintering techniques may be used, where the material to be sintered is placed within a die which is vibrated while heating to a sufficient temperature for the sintering to occur. An advantage of pressureless sintering is finer control of the metal content of the final material, as pressure sintering can cause the liquid metal to be pressed out of the material.

Depending on the neutron and gamma flux incident on the shield as well as the duration of any pulses (if the fusion device is not operated in steady state mode) then it may be desirable to integrate a cooling system with the shield to maintain the shield within thermal operating limits. Such a cooling system may take the form of channels within the shield through which a coolant such as gaseous helium is pumped. Water cooling may also be used to extract heat from the system, optionally via a suitable metallic interface to minimise corrosion. Alternatively, by maintaining a heat sink in one or more regions of the shield, heat can be extracted from the shield thermal conduction.

W₂B₅ imposes an additional advantage over the use of a WC or pure W shield, in that it has far superior oxidation resistance. This is an important safety consideration for a worst-case accident scenario combining loss-of-coolant (LOCA) with loss-of-vacuum (LOVA).

The W₂B₅ shielding is particularly advantageous in situations where space for the neutron shielding is highly constrained. One such example is neutron shielding in a tokamak fusion reactor, particularly a spherical tokamak. In such a reactor, the shielding is protecting poloidal or toroidal field coils from neutrons emitted by the fusing plasma within the plasma chamber. The coils may be made from relatively delicate high temperature superconducting material, so an effective shield is necessary—but the efficiency of the reactor can be improved if this shield is as thin as possible, since that allows a more favourable spherical geometry, and for the field coils to be closer to where the magnetic field is needed.

1. A di-tungsten penta-boride, W₂B₅, for use within a neutron shield.

2. The di-tungsten penta-boride according to claim 1, wherein a proportion of boron-10 as a proportion of the total boron content of the W₂B₅ is greater than 18%, more preferably greater than 20%, more preferably greater than 25%.

3. The di-tungsten penta-boride according to claim 1, wherein the W₂B₅ is provided as solid sintered W₂B₅.

4. The di-tungsten penta-boride according to claim 1, wherein the W₂B₅ is provided within a composite material comprising W₂B₅ and a metal.

5. The di-tungsten penta-boride according to claim 4, wherein the metal is one of:
a transition metal;
a metal of group 11 of the periodic table;
zinc;
lead;
aluminium;
an alloy primarily composed of a transition metal, a metal of group 11 of the periodic table, zinc, lead, or aluminium.

6. The di-tungsten penta-boride according to claim 5, wherein the metal is copper.

7. The di-tungsten penta-boride according to claim 4, wherein the composite material is a cemented tungsten boride comprising a metal matrix and an aggregate, the aggregate comprising W₂B₅.

8. The di-tungsten penta-boride according to claim 4, wherein the composite material comprises at least 70% by weight W₂B₅, more preferably at least 80% by weight W₂B₅, more preferably at least 90% by weight W₂B₅.

9. A neutron shielding comprising di-tungsten penta-boride, W₂B₅.

10. The neutron shielding according to claim 9, wherein a proportion of boron-10 as a proportion of the total boron content of the W₂B₅ is greater than 18%, more preferably greater than 20%, more preferably greater than 25%.

11. The neutron shielding according to claim 9, and wherein the W₂B₅ is solid sintered W₂B₅.

12. The neutron shielding according to claim 9, wherein the W₂B₅ is provided within a composite material comprising W₂B₅ and a metal.

13. The neutron shielding according to claim 12, wherein the metal is one of:
a transition metal;
a metal of group 11 of the periodic table;
zinc;
lead;
aluminium;
an alloy primarily composed of a transition metal, a metal of group 11 of the periodic table, zinc, lead, or aluminium.

14. The neutron shielding according to claim 13, wherein the metal is copper.

15. The neutron shielding according to claim 12, wherein the composite material is a cemented tungsten boride comprising a metal matrix and an aggregate, the aggregate comprising W₂B₅.

16. The neutron shielding according to claim 12, wherein the composite material comprises at least 70% by weight W₂B₅, more preferably at least 80% by weight W₂B₅, more preferably at least 90% by weight W₂B₅.

17. A tokamak fusion reactor comprising a plasma chamber, a toroidal field coil, a plurality of poloidal field coils, and neutron shielding located between the interior of the plasma chamber and the toroidal or poloidal field coils, wherein the neutron shielding is shielding according to claim 9.
